(19) United States
(12) Patent Application Publication
(10) Pub. No.: US 2007/0001472 A1
(43) Pub. Date: Jan. 4, 2007

(54) Gripping arm assembly for loading a filled inner container into an outer container

(76) Inventor: John Joseph Hildebrand JR., Corona, CA (US)

Correspondence Address: THE WATSON INTELLECTUAL PROPERTY GROUP, PLC, 3133 HIGHLAND DRIVE, SUITE 200, HUDSONVILLE, MI, 49426, US

(21) Appl. No.: 11/398,497

(22) Filed: Apr. 5, 2006

Related U.S. Application Data
(62) Division of application No. 10/402,289, filed on Mar. 28, 2003, now Pat. No. 6,978,542.

(51) Int. Cl. B25J 15/02

(52) U.S. Cl. 294/88; 294/106; 414/409; 414/586

(57) ABSTRACT

A gripping assembly for loading a substantially filled inner container having a plurality of comer regions into an outer container. The gripping assembly comprises a frame and a plurality of gripping arms. Each of the gripping arms further includes a first end and a second end. The first end is movably coupled to the frame. The second end is distally spaced from the first end. The plurality of gripping arms are positionable so as to substantially correspond with the plurality of comer regions of the substantially filled inner container. Additionally, the controlled movement of the gripping arms relative to the frame facilitates retention and release of the plurality of comer regions of the inner container.

### CROSS-REFERENCE TO RELATED APPLICATION

This application is a divisional of U.S. patent application Ser. No. 10/402,289 filed Mar. 28, 2003 entitled “A Gripping Arm Assembly for Loading a Filled Inner Container into an Outer Container,” the entire specification of which is hereby incorporated by reference.

### BACKGROUND OF THE INVENTION

1. Field of the Invention

The present invention relates in general to bag in box handling, and more specifically, to a gripping arm assembly for loading a filled inner container into an outer container. Generally, the inner container is substantially flexible and the outer container is substantially rigid.

2. Background Art

The use of flexible packaging has become increasingly widespread. In particular, among other industries, the carbonated beverage industry relies heavily on the use of flexible inner containers surrounded by rigid outer containers for the packaging and transporting of syrup. While there have been great advances with the use of flexible inner containers within outer containers, certain problems have been realized. In particular, one such problem that has been encountered has been the proper placement of the inner container into an outer container upon the filling of the inner container (generally, with a fluid of varying viscosity).

Among other problems, it has been difficult to automate the proper packaging the inner container into an outer container. For example, it is desirable to place the fitment of the inner container proximate the fitment accepting opening of an outer container. Such placement is advantageous inasmuch as the time necessary to properly setup the container for discharge can be greatly decreased if the inner and outer containers are coordinated and properly assembled.

While certain systems have been attempted to achieve the proper coordinated placement of the inner container within the outer container, one problem that has persisted is that it is difficult to properly and controllably grasp and retain a flexible container that has been filled. In addition, even if the flexible inner liners can be adequately grasped and retained the handling equipment often damages the container during the steps of grasping, manipulating and/or release.

Accordingly, it is an object of the invention to provide gripping arms which properly orientates a flexible inner container for placement within an outer container.

It is another object of the invention to grasp and retain a flexible inner container for placement within an outer container without damaging the flexible inner container during grasping and/or release.

These objects as well as other objects of the present invention will become apparent in light of the present specification, claims, and drawings.

### SUMMARY OF THE INVENTION

The invention comprises a gripping assembly for facilitating the loading of a substantially filled inner container having a plurality of comer regions into an outer container. The gripping assembly comprises a frame and a plurality of gripping arms. The plurality of gripping arms are associated with the frame. Each of the gripping arms further include a first end and a second end. The first end is movably coupled to the frame. The second end is distally spaced from the first end. The plurality of gripping arms are positionable so as to substantially correspond with the plurality of comer regions of the substantially filled inner container. Additionally, the controlled movement of the gripping arms relative to the frame facilitates retention and release of the plurality of comer regions of the inner container.

In a preferred embodiment, the first end of each of the gripping arms is rotatably coupled to the frame. The plurality of gripping arms are configured so as to be movable from a first position wherein the gripping arms are divergently spaced from each other, to a second position wherein the plurality of gripping arms converge toward a central region.

In one such embodiment, the plurality of gripping arms comprise four gripping arms positioned at substantially 90° angles relative to each other, to, in turn, substantially define a rectangle.

In another aspect of the invention, the invention comprises a gripping assembly for facilitating the loading of a substantially filled inner container into an outer container. In such an aspect of the invention, the gripping assembly comprises a frame support and a plurality of gripping arms. The frame support is capable of vertically upward and downward movement relative to the receiving base. Each of the gripping arms further includes a first segment and a second segment. The first segment includes a first end pivotally associated with the frame support, wherein the first segments of the plurality of gripping arms can be directed in an inward and outward direction. The second segment is pivotally associated with the first segment a distance from the first end. The second segment further includes a container engaging end. The plurality of gripping arms are capable of releasably retaining a comer region of a substantially filled inner container by the engaging ends thereof.

In a preferred embodiment, the plurality of gripping arms comprises four gripping arms, the gripping arms positioned at substantially 90° relative to each other. In one such embodiment, the plurality of gripping arms pivot relative to the support frame so as to substantially converge toward a center region.

Preferably, the second segments of each of the gripping arms are capable of rotating from a first position which is substantially orthogonal to the respective first gripping arm to a second orientation.

The invention further comprises a method of assembling a substantially filled inner container into an outer container. The method comprises the steps of (a) directing a substantially filled inner container upon a receiving base; (b) gripping a plurality of comer regions of the substantially filled inner container with a plurality of gripping arms; (c) disengaging the substantially filled inner container from the receiving base; (d) orientating an outer container in a desirable position relative to the inner container; (e) moving at least one of the gripping arms from contact with a respective comer region of the substantially filled inner container; and (f) releasing the inner container into the outer container.

In a preferred embodiment, the gripping arms each comprise a first and a second segment, the step of gripping further comprising the step of rotating the first segment of each of the gripping arms inwardly relative to a support frame, such that the second segment of each of the gripping arms substantially engages a corner region of the substantially filled inner container.

In yet another preferred embodiment, the step of releasing comprises the step of rotating one of the first segment relative to the support frame and the second segment relative to the first segment, to, in turn, release the inner container from contact with the gripping arms.

In a preferred embodiment, the step of gripping comprises the step of inwardly converging at least four gripping arms toward each other.

### BRIEF DESCRIPTION OF THE DRAWINGS

The invention will now be described with reference to the drawings wherein:

FIG. 1 of the drawings is a perspective view of a gripping arm assembly of the present invention;

FIG. 2 of the drawings is a perspective view of a gripping arm assembly of the present invention, showing, in particular, the receiving of an inner container upon a receiving base;

FIG. 3 of the drawings is a perspective view of a gripping arm assembly of the present invention, showing, in particular, the grasping of an inner container thereby;

FIG. 4 of the drawings is a perspective view of a gripping arm assembly of the present invention, showing, in particular, the movement of the receiving base;

FIG. 5 of the drawings is a perspective view of a gripping arm assembly of the present invention, showing, in particular, the positioning of the inner container in a desired position relative to the outer container;

FIG. 6 of the drawings is a perspective view of a gripping arm assembly of the present invention, showing, in particular, the release of the inner container into the outer container;

FIG. 7 of the drawings is a perspective view of a gripping arm assembly of the present invention, showing, in particular, the assembled inner and outer containers; and

FIG. 8 of the drawings is a perspective view of an inner container and an outer container used in association with a gripping arm assembly of the present invention.

### DETAILED DESCRIPTION OF THE INVENTION

While this invention is susceptible of embodiment in many different forms, there is shown in the drawings and described herein in detail a specific embodiment with the understanding that the present disclosure is to be considered as an exemplification of the principles of the invention and is not intended to limit the invention to the embodiment illustrated.

It will be understood that like or analogous elements and/or components, referred to herein, may be identified throughout the drawings by like reference characters. In addition, it will be understood that the drawings are merely schematic representations of the invention, and some of the components may have been distorted from actual scale for purposes of pictorial clarity.

Referring now to the drawings and in particular to FIG. 1, gripping arm assembly for gripping a flexible inner container is shown generally at 14. The gripping arm assembly is designed for use in association with a filler device (not shown) to assemble containers, such as container 80 (FIG. 8). The filler device may comprise any number of different filler devices which may be rotary filler devices, indexed filler devices, sequential filler devices, among others. Indeed, the type of filler device with which the gripping arm assembly is associated may be varied and is not limited to any particular filler device.

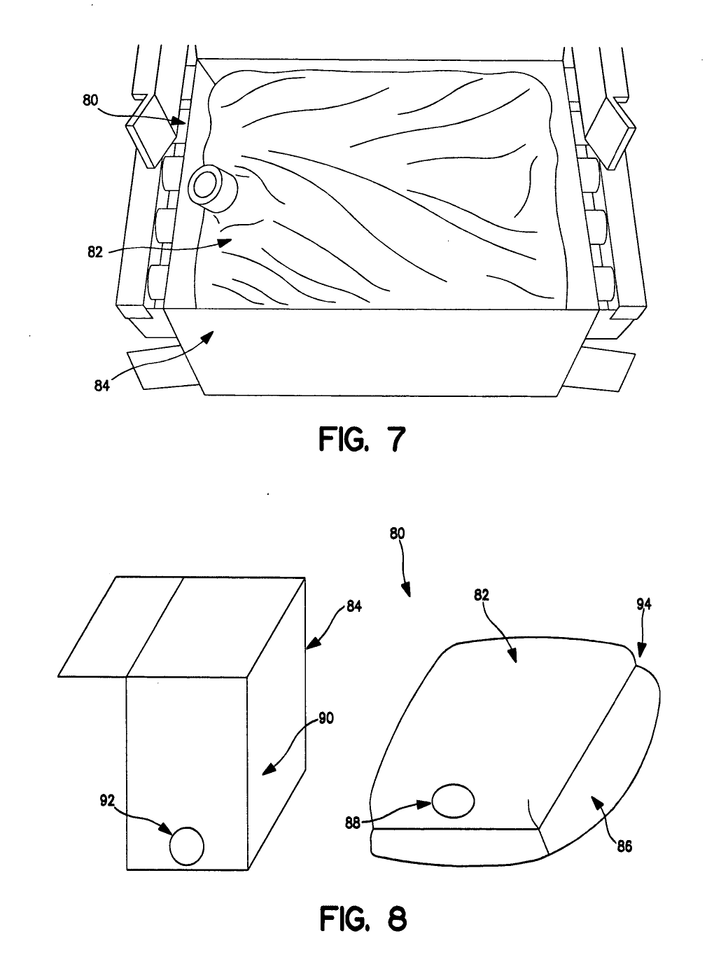

One embodiment of container 80 is shown in an assembled state in FIG. 7 and in an unassembled state in FIG. 8, as, generally, including inner flexible container 82 and outer container 84. Inner flexible container 82 generally comprises a plurality of panels 86 and fitment 88 (although a fitmentless inner flexible container is likewise contemplated). Depending on the particular embodiment, the plurality of panels may form a pillow flexible container having comer regions, such as comer region 94. Of course, it is likewise contemplated that the panels may form a form fitted container or a custom dimensioned container. The panels may be connected by way of heat sealing, RF sealing, adhesive sealing, etc. Fitment 88 extends through at least one of the plurality of panels, such that the fitment may be utilized for filling and/or for discharging the contents of the inner flexible container. Of course, fitment 88 is not limited to any particular configuration, and, indeed, the fitment may comprise any number of different constructions suitable for use in association with such flexible containers.

Outer container 84 is likewise shown in FIG. 8 as comprising a plurality of walls, such as wall 90 and may include fitment region 92. In the embodiment shown, the plurality of walls cooperate to define a substantially rectangular box. Of course, the particular shape and orientation of the walls can be varied and is not limited to the embodiment shown. Fitment region 92 is shown in FIG. 8 as being associated with one of the plurality of walls. In the embodiment shown, the fitment region includes an opening through which fitment 88 can be extended for discharge. While not required, in many embodiments, the opening of fitment region 92 may be perforated to facilitate the puncturing and positioning of the fitment therethrough.

It will be understood that often during assembly of an inner container into an outer container, comer regions 94 impede smooth insertion of the inner container and comer regions 94 remain outside of the confines of the inner container. As such, it is not uncommon for the comer regions to be pinched, breached or otherwise damaged when the outer container is closed and/or sealed.

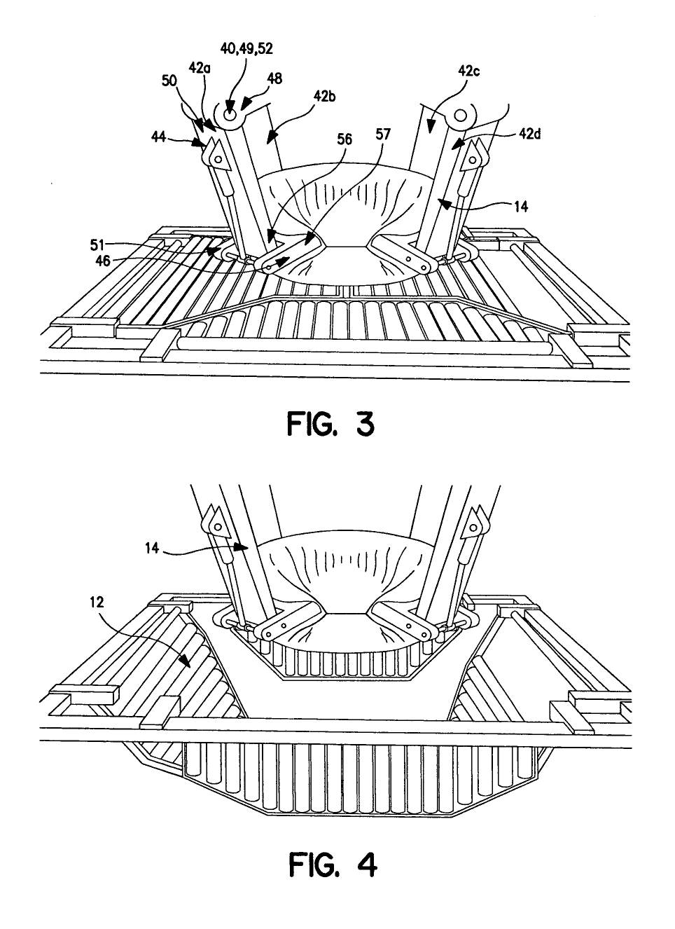

Gripping arm assembly 14 is shown in FIG. 3 as comprising support frame 40 and gripping arms, such as gripping arms 42a-d. Support frame 40 includes a movement assembly 48 which facilitates the movement of the portion of the frame to which the gripping arms are associated to vertically translate in an upward and downward direction in a controllable manner, and to horizontally translate in any desired direction. Of course, a variety of different movement assemblies are contemplated for use, namely, those that are driven by pneumatic, motor controlled and hydraulic means, among others.

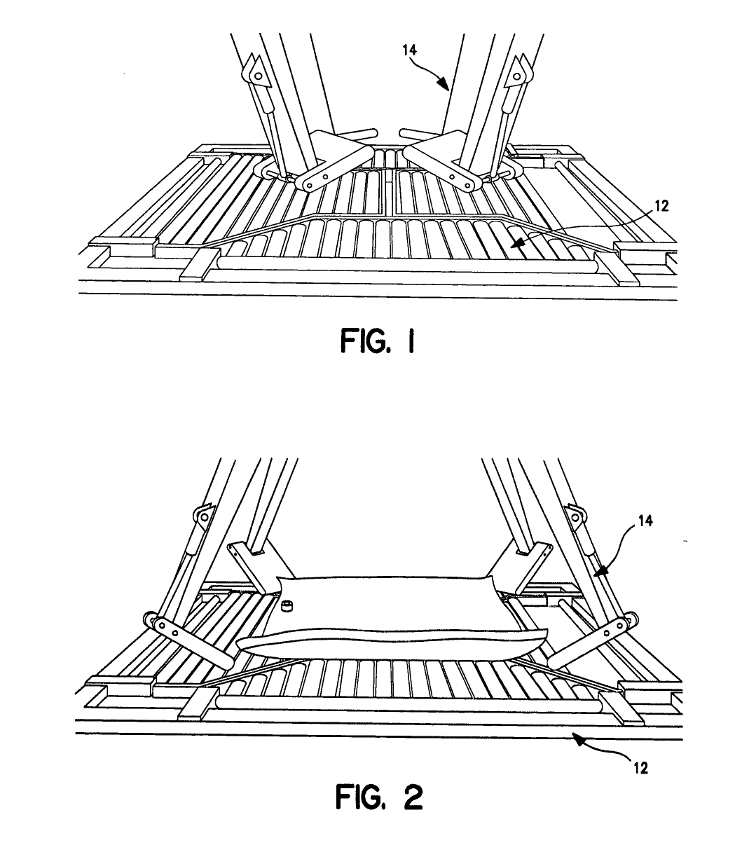

It is contemplated that each of the gripping arms 42a-d are associated with support frame 40. It will be understood that the gripping arms 42a-d are configured so as to collectively grasp a container about the comer regions thereof. Inasmuch as the container shown in FIGS. 2 and 8 used in association with the present invention includes four comer regions, such as comer regions 94, a total of four gripping arms are contemplated for use. In other embodiments, such as those intended for use with containers having a greater for lesser number of comer regions, a greater or a lesser number of gripping arms may be employed.

Gripping arm 42a will be described with the understanding that the gripping arms 42b-d are substantially identical thereto. In particular, gripping arm 42a is shown in detail in FIG. 3 as comprising first segment 44, second segment 46, and rotating assembly 49. First segment 44 includes first end 50 and second end 51. First end 50 is rotatably associated with support frame 40 and capable of inward and outward movement from a first inward position to a second outward position. Second end 51 is distally displaced from first end 50. Second segment 46 includes first segment interfacing region 56 and container interfacing end 57. First segment interfacing region 56 includes an assembly which facilitates the rotatable association thereof with second end 51 of first segment 44 of gripping arm 42a. Preferably the first and second segments comprise a plastic material which may be molded or machined into a desired configuration. Of course, various other materials, including, but not limited to metals, composites, etc. are likewise contemplated for use.

In another embodiment, instead of rotatably mounting the first end of the gripping arms to the support frame, first end 50 may be slidably positionable relative to support frame 40. In such an embodiment, frame 40 may include a longitudinal locating member and first end 50 of gripping arm 42 may include an interface member. The interface member is configured so as to be controllably positionable along the locating member. For example, the longitudinal locating member may comprise a threaded member which interfaces with corresponding teeth of the interface member. In other embodiments, the longitudinal locating member may comprise a pneumatic piston/cylinder assembly, wherein the interface member is attached thereto. Of course, other embodiments are likewise contemplated.

It is further contemplated that the first segment of each of the gripping arms may comprise a telescoping or extending assembly which would be capable of vertically moving second end 51 of first segment 44 without substantially moving first end 50. In such an embodiment, the support frame 40 may be stationary and substantially free from movement.

In yet another embodiment, support frame 40 may additionally include an assembly which imparts rotation movement upon the support frame, and in turn, rotation of gripping arms 42. In such an embodiment, the gripping arms can be rotated relative to the receiving base (and the inner container positioned thereon), until positioned in the desired orientation for activation, and, in turn, retention of the inner container.

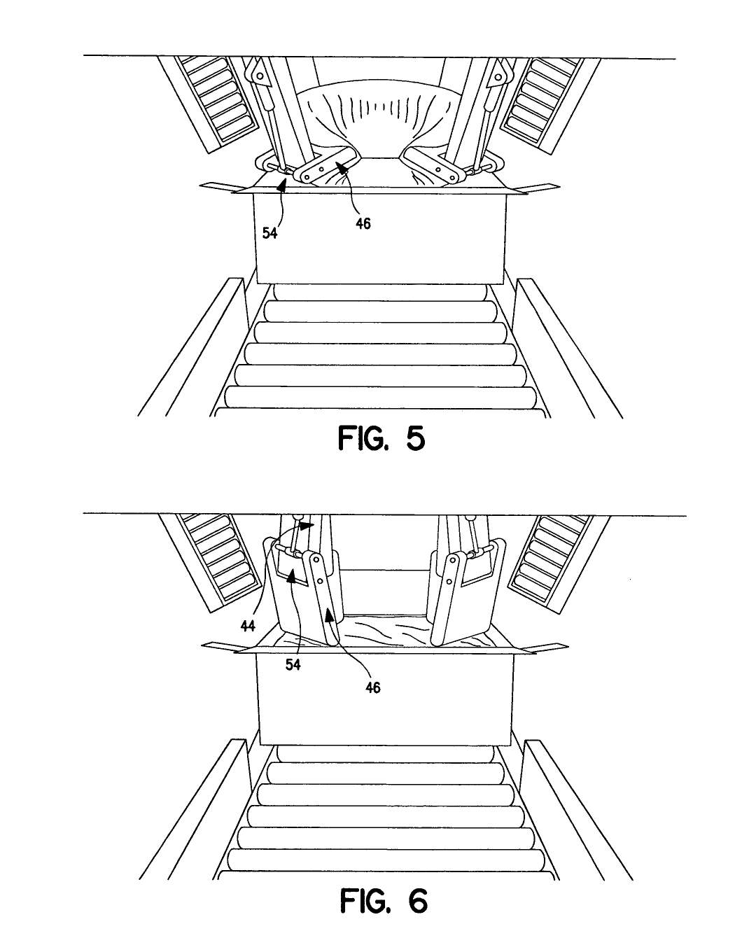

Rotating assembly 49 includes first rotating assembly 52, shown in FIG. 3, and second rotating assembly 54, shown in FIGS. 5 and 6. First rotating assembly 52 includes an actuator which facilitates the rotation of first segment 44 relative to support frame 40 in a substantially inward and outward direction. First rotating assembly may comprise any number of different assemblies, including, but not limited to, pneumatic, motor driven, and hydraulic systems, among others. Second rotating assembly 54 comprises an actuator which facilitates the rotation of the second segment relative to the first segment from a first orientation wherein the first and second segments are at substantially right angles, to a second orientation wherein the first and second segments are substantially collinear. Of course, in various embodiments, the range of movement of the second segment relative to the first segment may be increased or decreased. In addition the first and second orientation, which are substantially 90° apart may be varied so as to be greater or less than 90°.

As is shown in FIG. 1, the four gripper arms can be directed by first rotating assembly 52 of each of the gripper arms toward a central region. Depending on the particular embodiment, the central region may comprise a single converging point, or a converging line.

In operation, a container is positioned, as desired on receiving base 12 to be picked up by gripping arm assembly 14. Indeed, a number of different bases are contemplated for use. Certain of the receiving bases may be fixed in a particular orientation, while other receiving bases may be capable of translating either or both of vertically and horizontally. Still other receiving bases may have component portions which are capable of translating either or both of vertically or horizontally (i.e., trap doors, etc.). It is preferred that the container is directed onto the receiving base such that the comers of the container substantially correspond to the position of the gripping arms. Although, in other embodiments, the gripping arm assembly can be independently rotated and/or translated so as to position the gripping arms in such an orientation that the gripping arms substantially correspond to the comer regions.

Next, gripping arm assembly 14 is positioned into a desired orientation relative to the receiving base. As needed, the gripping arms 42a-42d are rotated in an outward direction relative to support frame 40. Furthermore, second rotating assembly 54 positions the second segments of the gripping arms in an orientation which is substantially orthogonal to the respective first segments. Of course, various different embodiments are contemplated wherein the initial orientation of the two segments may be at an angle other than substantially orthogonal. Of course, these preparations of the gripping arms can be completed prior to the receipt of the inner container onto the receiving base.

As is shown in FIG. 3, once the gripping arm assembly is properly positioned, the first segments are rotated by the first rotating assembly such that the container engaging end 57 of the second segment 46 of each of the gripping arms engages each of the corner regions thereof and preferably substantially proximate the midpoint or seam thereof. In such a grasping configuration, as the container is lifted from the receiving base, or as the receiving base is moved, the container exhibits a substantially “teardrop” configuration. Essentially, the gripping arms cooperate to pinch the container therebetween, proximate the comer regions 94. Inasmuch as the comers of the container have been grasped by the gripping arms, the gripping arms retain the container in a stable orientation substantially confined from movement. Moreover, by gripping the comer regions (i.e., the regions of the container which generally protrude from an outer container upon positioning the inner container within the outer container), interference and or failure of a container which generally occurs about the comer regions, can be minimized. Moreover, grasping of the comer regions facilitates enhanced and improved retention and manipulation of the inner container.

As is shown in FIGS. 4 and 5, once the container has been stabilized in the retained orientation, either the gripping arm assembly is moved or the receiving base is moved so that the gripping arms and the inner container retained by the gripping arms are positioned in close proximity with an outer container.

As is shown in FIG. 6, once the inner and outer containers are positioned in a desired spatial orientation (i.e., the inner container is positioned above the outer container), the second rotating assembly 54 is actuated thereby rotating second segment 46 relative to first segment 44 of each gripping arm, to, in turn, release the inner container into the outer container. In certain embodiments, first rotating assembly 52 may likewise be actuated such that the first segments rotate in a generally outward direction relative to support frame 40.

As the inner container is released, the inner container drops into the outer container. Inasmuch as the comers of the container were substantially retained by the gripping arms, the container is controllably dropped such that the comers of each of the inner and outer containers substantially correspond (FIG. 7). Moreover, the due to the retention of the inner container about the comer regions, when released, the comer regions of the inner container do not protrude outwardly. As such, the contact of the comer regions against the outer container is minimized, and, in turn, any possibility of snagging against the outer container is substantially eliminated. Once the outer and inner containers are assembled, the gripping arms may be repositioned so as to repeat the foregoing assembly process.

Of course, in other embodiments, the gripping arms may have different structural configurations, and the gripping arms may be disengaged from contact with the comer regions of the inner container in a different manner. For example, where each gripping arm assembly comprises a rigid arm, the entire arm may be moved outwardly, away from the inner container to effectuate the release of the inner container.

In any of a number of different embodiments, it is likewise contemplated that the gripping arms may be released in sequence, instead of substantially at the same time. For example, two of the gripping arms can release to first impart rotation upon the outer container, before the remaining gripping arms release the inner container. In other embodiments, rotation and translation of the inner container is achieved by sequential release of gripping arms from the comer regions of the container. Indeed, the release of the gripping arms can be coordinated such that any number of different rotational and translational movements can be exhibited by the selectively released container.

The foregoing description merely explains and illustrates the invention and the invention is not limited thereto except insofar as the appended claims are so limited, as those skilled in the art who have the disclosure before them will be able to make modifications without departing from the scope of the invention.

What is claimed is:

1. A gripping assembly for facilitating the loading of a substantially filled inner container having a plurality of comer regions into an outer container, the gripping assembly comprising:
a frame; and
a plurality of gripping arms associated with the frame, each of the gripping arms further including:
a first end movably coupled to the frame; and
a second end distally spaced from the first end, wherein the plurality of gripping arms are positionable so as to substantially correspond with the plurality of comer regions of the substantially filled inner container, and wherein the controlled movement of the gripping arms relative to the frame facilitates retention and release of the plurality of comer regions of the inner container.

2. The gripping assembly of claim 1 wherein the first end of each of the gripping arms is rotatably coupled to the frame, and wherein the plurality of gripping arms are configured so as to be movable from a first position wherein the gripping arms are divergently spaced from each other, to a second position wherein the plurality of gripping arms converge toward a central region.

3. The gripping assembly of claim 2 wherein the plurality of gripping arms comprise four gripping arms positioned at substantially 90° angles relative to each other, to, in turn, substantially define a rectangle.

4. A gripping assembly for facilitating the loading of a substantially filled inner container into an outer container, the gripping assembly comprising:
a frame support, the frame support capable of vertically upward and downward movement relative to the receiving base;
a plurality of gripping arms, each of the gripping arms further including:
a first segment having a first end pivotally associated with the frame support, wherein the first segments of the plurality of gripping arms can be directed in an inward and outward direction; and
a second segment pivotally associated with the first segment a distance from the first end, the second segment further including a container engaging end,
wherein the plurality of gripping arms are capable of releasably retaining a comer region of a substantially filled inner container by the engaging ends thereof.

5. The gripping assembly of claim 4 wherein the plurality of gripping arms comprises four gripping arms, the gripping arms positioned at substantially 90° relative to each other.

6. The gripping assembly of claim 5 wherein the plurality of gripping arms pivot relative to the support frame so as to substantially converge toward a center region.

7. The gripping assembly of claim 4 wherein the second segments of each of the gripping arms are capable of rotating from a first position which is substantially orthogonal to the respective first gripping arm to a second orientation.

8. A method of assembling a substantially filled inner container into an outer container, the method comprising the steps of:
directing a substantially filled inner container upon a receiving base;
gripping a plurality of comer regions of the substantially filled inner container with a plurality of gripping arms;
disengaging the substantially filled inner container from the receiving base;
orientating an outer container in a desirable position relative to the inner container the at least one support surface;
moving at least one of the gripping arms from contact with a respective comer region of the substantially filled inner container;
releasing the inner container into the outer container.

9. The method of claim 8 wherein the gripping arms each comprise a first and a second segment, the step of gripping further comprising the step of rotating the first segment of each of the gripping arms inwardly relative to a support frame, such that the second segment of each of the gripping arms substantially engages a comer of the substantially filled inner container.

10. The method of claim 9 wherein the step of releasing comprises the step of rotating one of the first segment relative to the support frame and the second segment relative to the first segment, to, in turn, release the inner container from contact with the gripping arms.

11. The method of claim 8 wherein the step of gripping comprises the step of inwardly converging at least four gripping arms toward each other.
